(19) United States
(12) Patent Application Publication
(10) Pub. No.: US 2020/0178064 A1
(43) Pub. Date: Jun. 4, 2020

(54) Directionally Oriented Wireless Voice Communication with Optional Telephony or Network Handoff

(71) Applicant: Encarnacion Gonzalez, Alice, TX (US)

(72) Inventor: Encarnacion Gonzalez, Alice, TX (US)

(21) Appl. No.: 16/355,722

(22) Filed: Mar. 16, 2019

Related U.S. Application Data
(63) Continuation-in-part of application No. 16/283,792, filed on Feb. 24, 2019, now abandoned.
(60) Provisional application No. 62/774,538, filed on Dec. 3, 2018.

(51) Int. Cl. H04W 8/26; H04W 80/02; H04W 80/04; H04W 4/80; H04W 76/11; H04M 1/253

(52) U.S. Cl. CPC H04W 8/26; H04W 80/02; H04M 1/2535; H04W 4/80; H04W 76/11; H04W 80/04

(57) ABSTRACT

A cellular telephone or similar wireless device that possesses a directionally oriented wireless telecommunications facility using a local area network to initiate and operate a wireless connection. Optionally, the devices share mobile identification numbers (MINs), IP addresses, or MAC addresses. Also optionally, the devices create contacts in their contact databases reflecting the identity of the connection. By this means, a subsequent telephony-based or LAN-based connection may be instituted.

### CROSS-REFERENCE TO RELATED APPLICATIONS

This application takes benefit of U.S. patent application Ser. No. 16/283,792 filed Feb. 24, 2019 which is included in its entirety by reference. That application takes benefit of U.S. Prov. Pat. No. 62/774,538 filed Dec. 3, 2018 which is also included in its entirety by reference.

### FIELD OF THE INVENTION

A cellular telephone or a similar wireless device that possesses a directionally oriented wireless telecommunications facility that uses a local area network to initiate and operate a wireless connection. Optionally, the devices share mobile identification numbers (MINs) or other identifying information. Also, optionally, the devices create contacts in their contact databases reflecting the identity of the connection. By this means, a subsequent telephony-or internet based connection may be instituted.

### BACKGROUND OF THE INVENTION

The invention relates to wireless communications devices, particularly to cellular telephones, that possess a directionally oriented wireless telecommunications facility that uses a local area network to initiate, and optionally share after initiation, the telephone number or device identity, with the other device.

In the prior art, no alternative method of instituting wireless communication with a nearby cellular telephone, or other wireless device, by means of directional designation (pointing) are known. By this means wireless communication with a specific wireless device may be instituted.

Similarly, no alternative method of sharing, after the initial wireless connection is made, the telephone number or device identity of the insinuating device with the terminating device is known. By this means a telephonic communications link may later be created between the two devices.

### SUMMARY OF THE INVENTION

In a first embodiment of the present invention, the directionally oriented wireless telecommunications facility is used to create a bidirectional communications link from one wireless device to another wireless device. The bidirectional communication link is directionally oriented. That is to say that the forward direction indicated by the long axis of the cellular telephone is the directional axis along which a wireless communications link is created. Those having skill in the art will, of course, recognize that any other axis of the cellular telephone may also be used.

The bidirectional communications link may be used to transmit voice, text, or data and this transmission occurs without the use of the cellular telephone network or internet. The bidirectional communications link establishes immediate wireless communication between the insinuating wireless device and a terminating wireless device using existing wireless technology and protocols including, but not limited to: Bluetooth; Wi-Fi; infrared radiation; radio waves; radio wireless technology; electromagnetic wireless technology; mobile broadband technology; and microwave radiation.

The bidirectional communications link requires a directional antenna to insinuate a connection sequence. The terminating wireless device communicates back using an omnidirectional antenna. After insinuating a wireless connection, the insinuating wireless device may switch to an omnidirectional antenna to continue communication with the terminating wireless device. Alternately, the insinuating wireless device may be required to communicate using the directional antenna.

The system works in the following manner: The insinuating wireless device is pointed so that its physical long axis is directed towards the terminating wireless device. Using its directional antenna, oriented so that it emits parallel to the physical long axis of the device, the insinuating wireless device transmits a connection invitation request to the intended terminating wireless device. Assuming the terminating wireless device allows connection invitations to be received, the terminating wireless device may, or may not, institute a connection with the insinuating wireless device. Whether the terminating wireless device does so or not is governed by the user of the terminating wireless device, if any. The user of the terminating wireless device is queried by a screen on the phone or tablet computer advising them that an insinuating wireless device is attempting to make a connection. If the user of the terminating wireless device selects not to create a connection with the insinuating wireless device, the terminating wireless device communicates back a negative response and the insinuating wireless device shows a screen to its user indicating that the user of the terminating wireless device does not desire that the requested connection be made. On the other hand, if the user of the terminating wireless device selects to create a connection with the insinuating wireless device, the terminating wireless device communicates back a positive response and the insinuating wireless device shows a screen to its user indicating that the user of the terminating wireless device desires that the requested connection be made. Two-way communication between the insinuating wireless device and the terminating wireless device begins. If there is no user, the terminating device queries a database to determine if the insinuating device is allowed to connect to it. If it is allowed, an acceptance of the request is sent back to the insinuating device. If it is not allowed to make a connection, a denial of the request is sent back to the insinuating device.

After this, the insinuating wireless device or the terminating wireless device may, or may not, request that the insinuating wireless device and the terminating wireless device exchange mobile identification numbers (MINs). The MIN is a number that uniquely identifies a mobile phone working under TIA standards for cellular and PCS technologies (e.g. EIA/TIA-553 analog, IS-136 TDMA, IS-95, or IS-2000 CDMA). It may also be referred to as the MSID (Mobile Station ID) or IMSI_S (Short IMSI). Similarly, the insinuating wireless device or the terminating wireless device may, or may not, request that the insinuating wireless device and the terminating wireless device exchange IP addresses or MAC addresses.

If the insinuating wireless device and the terminating wireless device agree to exchange MINs or IP or MAC addresses, they do so. One, or both, of the insinuating wireless device and the terminating wireless device may create contact records in associated contact databases reflecting the identity of the party with whom the connection has just been negotiated.

It will be obvious that any kind of wireless communication may occur at this point. Voice over internet protocol (VoIP) voice communication is preferred, but short message service (SMS) text messages, multimedia messaging service (MMS) messages, etc. may be initiated and may occur. Similarly, any type of data transmission (HTML, FTP, etc.) may occur.

If the insinuating and the terminating wireless device have exchanged MINs, it will be possible for the two devices to communicate using a standard cellular network. In this mode, the initiator accesses the MIN that was received after the non-cellular connection was completed and attempts to connect to it using the cellular network. Similarly, if the insinuating and the terminating wireless device have exchanged IP addresses or MAC addresses, it will be possible for the two devices to communicate using a standard IP network. In this mode, the initiator accesses the IP address or MAC address that was received after the identifying connection was completed and attempts to connect to it using the IP network.

Similarly, if the insinuating and the terminating wireless device have created contact records in their respective contact databases, it will also be possible for the two devices to communicate using a standard cellular network. In this mode, the initiator accesses the contact record containing the MIN that was received after the non-cellular connection was completed and attempts to connect to it using the cellular network. Similarly, if the insinuating and the terminating wireless device have been connected using an IP network, that connection may be reestablished.

### BRIEF DESCRIPTION OF THE DRAWINGS

FIG. 1 is a view of an insinuating wireless device and how it is oriented when attempting to solicit a connection from a terminating wireless device using a directional antenna.

FIG. 2 is a view of an insinuating wireless device and a terminating wireless device after the connection has been created and the insinuating wireless device switches to an omnidirectional antenna when an internet connection is created between the insinuating wireless device and the terminating wireless device.

FIG. 3 is a view showing how a cellular connection may be instituted after an internet connection has been made between an insinuating wireless device and a terminating wireless device, MINs have been exchanged, contacts have been created, and the internet connection has concluded.

FIG. 4 is a flowchart showing how an insinuating wireless device creates a directional connection that is altered to an omnidirectional connection; MINs are exchanged; and contact records are created. By this means a conventional cellular telephone call may be placed after an directionally oriented connection has been made between an insinuating wireless device and a terminating wireless device, MINs have been exchanged, contacts have been created, and the directionally oriented connection has concluded.

FIG. 5 is a view of an insinuating wireless device and how it is oriented when attempting to solicit an identifying connection from a terminating wireless serving device chosen from a multiplicity of wireless serving devices using a directional antenna.

FIG. 6 is a view showing how an IP connection may be instituted after a directionally oriented identifying connection has been made between an insinuating wireless device and a terminating wireless device after IP or MAC addresses have been exchanged and the directionally oriented identifying connection has concluded.

### DETAILED DESCRIPTION OF THE INVENTION

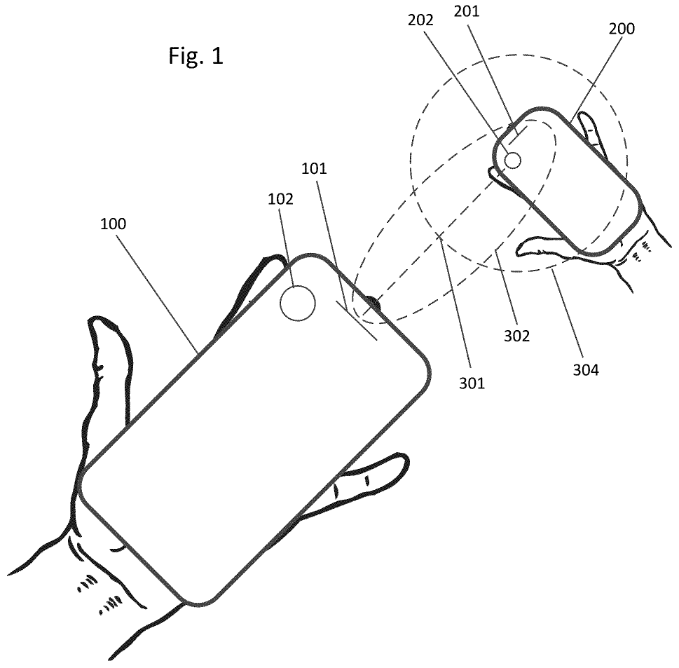

Turning now to FIG. 1, in one embodiment of the present invention, a directionally oriented wireless telecommunications facility is used to create bidirectional communication link 301 from an insinuating wireless device 100 to a terminating wireless device 200.

Bidirectional communication link 301 directionally orients RF field 302 from the horizontal forward leading edge of insinuating wireless device 100. That is to say, that the long axis of insinuating wireless device 100 is collinear with bidirectional communication link 301 along which directionally oriented RF field 302 is created. Those having skill in the art will, of course, recognize that any other axis of insinuating wireless device (e.g. transverse and rear) 100 may also be used.

Those having skill in the art will recognize that directional antenna 101 may be of any construction, including but not limited to: a directional micro strip antenna, a Yagi antenna, or a parabolic antenna. Since one embodiment of the insinuating wireless device 100 exists in a cellular telephone, a directional microstrip antenna is a preferred embodiment.

In the first phase of the connection sequence, insinuating wireless device 100 creates an RF field 302 generally oriented along bidirectional communication link 301. Insinuating wireless device 100 continually transmits a connection request through RF field 302 oriented along bidirectional communication link 301. Potential terminating wireless device 200 receives the connection request by means of omnidirectional antenna 202 with omnidirectional field 304, and, under the direction of its user, transmits an acceptance of the connection request. This acceptance of the connection request is received by directional antenna 101 of insinuating wireless device 100. Those having skill in the art will recognize that alternately omnidirectional antenna 102 may be used to receive the acceptance of the connection request.

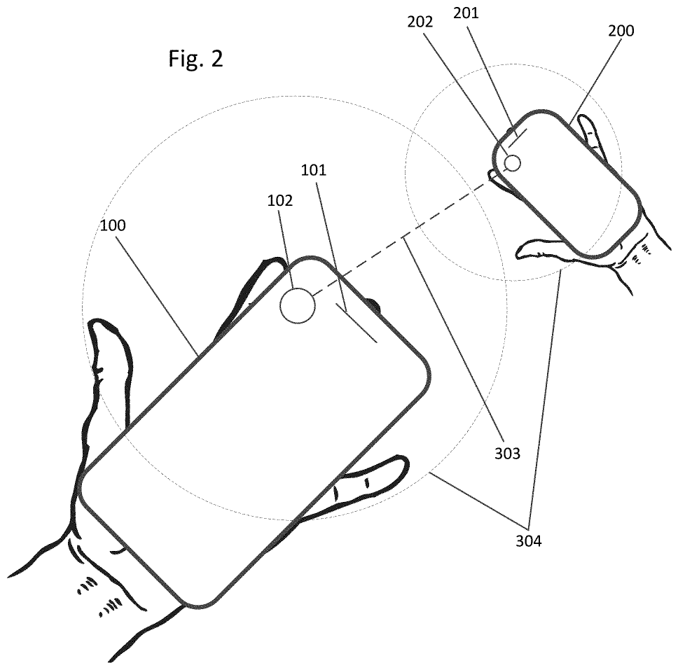

Referring now to FIG. 2, in the second phase of the connection sequence, insinuating wireless device 100 switches to its omnidirectional antenna 102 and institutes bidirectional wireless connection 303 with terminating wireless device 200 by means of its omnidirectional antenna 202. Those having skill in the art will recognize that alternately omnidirectional antenna 102 may already have been used to receive the acceptance of the connection request and that the switch may have already been performed.

Those having skill in the art will recognize that bidirectional wireless connection 303 may be in any form, including but not limited to local area wireless technologies such as Bluetooth, Wi-Fi, WiMAX, WAP 2.0, iBurst, Flash-OFDM, infrared radiation, radio waves, radio wireless technology, electromagnetic wireless technology, mobile broadband technology such as LTE, EDGE Evolution, UMTS, EV-DO, and microwave radiation. Those having skill in the art will recognize that in one embodiment of the present invention that bidirectional wireless connection 303 is point-to-point. Similarly, those having skill in the art will recognize that in another embodiment of the present invention that bidirectional wireless connection 303 may be relayed through an access point.

In one embodiment of the present invention, bidirectional wireless connection 303 establishes communication between an insinuating wireless device 100 such as an insinuating cellular telephone and a terminating wireless device 200 such as a terminating cellular telephone. Bidirectional wireless connection 303 may be used to transmit voice, text, or data and this transmission occurs without the use of the cellular telephone network.

After bidirectional wireless connection 303 has been instituted, insinuating wireless device 100 such as an insinuating cellular telephone and terminating wireless device 200 such as a terminating cellular telephone may, or may not, request that the insinuating wireless device 100 and the terminating wireless device 200 exchange mobile identification numbers (MINs). The MIN is an identifier that uniquely identifies a mobile phone working under TIA standards for cellular and PCS technologies (e.g. EIA/TIA-553 analog, IS-136 TDMA, IS-95, or IS-2000 CDMA). It may also be referred to as the MSID (Mobile Station ID) or IMSI_S (Short IMSI). Similarly, insinuating wireless device 100 such as an insinuating cellular telephone and terminating wireless device 200 such as a terminating cellular telephone may, or may not, request that the insinuating wireless device 100 and the terminating wireless device 200 exchange IP addresses or MAC addresses. Those having skill in the art will recognize that these are not the only identifiers that may be exchanged and that all such identifiers are include by reference.

If the insinuating wireless device 100 and the terminating wireless device 200 agree to exchange MINs, they do so. One, or both, of the insinuating wireless device 100 and the terminating wireless device 200 may then create contacts reflecting the identity of the party with whom bidirectional wireless connection 303 has just been negotiated. If the insinuating wireless device 100 and the terminating wireless device 200 agree to exchange IP or MAC addresses, they also do so. One, or both, of the insinuating wireless device 100 and the terminating wireless device 200 may then create contacts reflecting the identity of the party with whom bidirectional wireless connection 303 has just been negotiated.

It will be obvious that any kind of wireless communication may occur at this point. VoIP voice communication is preferred, but short message service (SMS) text messages, multimedia messaging service (MMS) messages, etc. may be initiated and may occur. Similarly, other data communications such as FTP and HTML may also occur.

lithe insinuating wireless device 100 and the terminating wireless device 200 have exchanged MINs, it will be possible for the two devices to communicate using a standard cellular network. In this mode, the initiator accesses the MIN that was received after bidirectional wireless connection 303 was completed and attempts to connect to it using the cellular network. Similarly, if the insinuating wireless device 100 and the terminating wireless device 200 have exchanged IP or MAC addresses, it will be possible for the two devices to communicate using a standard IP network. In this mode, the initiator accesses the IP or MAC address that was received after bidirectional wireless connection 303 was completed and reestablishes the connection via the IP network.

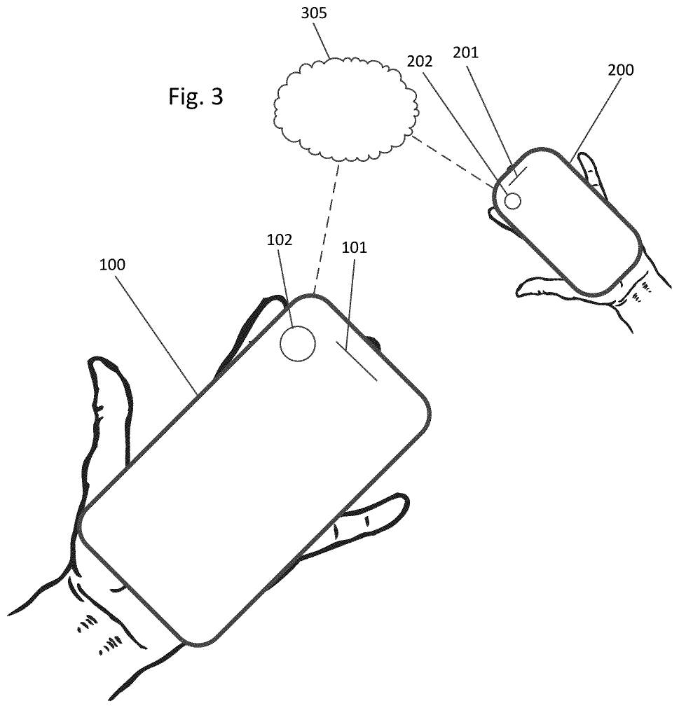

Referring now to FIG. 3, if insinuating wireless device 100 and the terminating wireless device 200 have created contacts it will also be possible for the two devices to communicate using standard cellular network 305. In this mode, the initiator accesses the contact record containing the MIN that was received after the non-cellular bidirectional wireless connection 303 was completed and attempts to connect to it using standard cellular network 305.

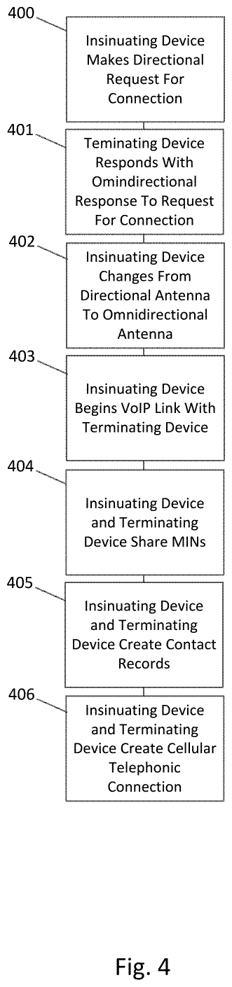

Referring now to FIGS. 1 through 4, the system works in the following manner: Insinuating wireless device 100 is pointed so that its physical long axis is directed towards the terminating wireless device 200. Assuming its directional antenna 101 is oriented to transmit along the device's physical long axis, the insinuating wireless device 100 transmits a connection invitation towards the omnidirectional antenna 202 of the intended terminating wireless device 200 (400).

Assuming the terminating wireless device 200 allows connection invitations to be received the terminating wireless device 200 may institute a connection with the insinuating wireless device 100. Whether the terminating wireless device 200 does so or not, is governed by the user of the terminating wireless device 200. The user of the terminating wireless device 200 is queried by a display screen on their phone advising them that an insinuating wireless device 100 is attempting to make a connection. If the user of the terminating wireless device 200 selects not to create a connection with the insinuating wireless device 100, the terminating wireless device 200 communicates back a negative response and the insinuating wireless device 100 shows a screen to its user indicating that the user of the terminating wireless device 200 does not desire that the requested connection be made. On the other hand, if the user of the terminating wireless device 200 selects to create a connection with the insinuating wireless device 100, the terminating wireless device 200 communicates back a positive response and the insinuating wireless device 100 shows a screen to its user indicating that the user of the terminating wireless device 200 desires that the requested connection be made (401).

Next, insinuating wireless device 100 changes from its directional antenna 101 to its omnidirectional antenna 102 and two-way, omnidirectional communication between the insinuating wireless device 100 and the terminating wireless device 200 begins (402).

Next, insinuating wireless device 100 and terminating wireless device 200 preferably begin a VoIP link between the two devices. Those having skill in the art will recognize that other communications protocols and applications can take advantage of the link between the two devices. For example, short message service (SMS) text messages and multimedia messaging service (MMS) messages, etc. also may be initiated and may occur. Similarly, data communication such as FTP and HTML may also occur (403).

Next, the insinuating wireless device 100 and the terminating wireless device 200 may, or may not, request that the insinuating wireless device 100 and the terminating wireless device 200 exchange mobile identification numbers (MINs). If the insinuating wireless device 100 and the terminating wireless device 200 agree to exchange MINs, they do so. Similarly, the insinuating wireless device 100 and the terminating wireless device 200 may, or may not, request that the insinuating wireless device 100 and the terminating wireless device 200 exchange IP or MAC addresses. If the insinuating wireless device 100 and the terminating wireless device 200 agree to exchange IP or MAC addresses, they do so (404).

One, or both, of the insinuating wireless device 100 and the terminating wireless device 200 may create contacts containing the MIN or the IP or MAC address reflecting the identity of the party with whom the connection has just been negotiated. Those having skill in the art will recognize that those newly created contacts will be stored in a contact database on the insinuating wireless device 100 and the terminating wireless device 200 (405).

Similarly, if the insinuating wireless device 100 and the terminating wireless device 200 have created contacts it will be possible for the two devices to communicate using a standard cellular or IP network. In this mode, the initiator accesses the contact record containing the MIN or the IP or MAC address that was received after the initial connection was completed and attempts to connect to it using a standard cellular network 305 or a standard IP network (406).

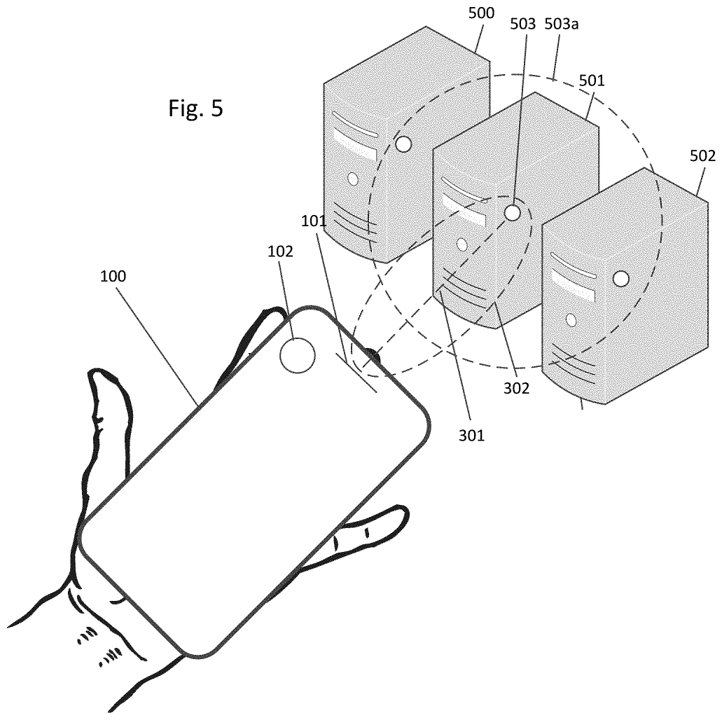

Turning now to FIG. 5, in one embodiment of the present invention, the directionally oriented wireless telecommunications facility is used to create bidirectional identifying communication link 301 from an insinuating wireless device 100 to a terminating wireless server device 501 selected from a multiplicity of other wireless server devices, e.g. 500 and 502.

Bidirectional communication link 301 directionally orients RF field 302 from the horizontal forward leading edge of insinuating wireless device 100. That is to say, that the long axis of insinuating wireless device 100 is collinear with bidirectional identifying communication link 301 along which directionally oriented RF field 302 is created. Those having skill in the art will, of course, recognize that any other axis of insinuating wireless device (e.g. transverse and rear) 100 may also be used.

Those having skill in the art will recognize that directional antenna 101 may be of any construction, including but not limited to: a directional micro strip antenna, a Yagi antenna, or a parabolic antenna. Since one embodiment of the insinuating wireless device 100 exists in a cellular telephone, a directional micro strip antenna is a preferred embodiment.

In the first phase of the connection sequence, insinuating wireless device 100 creates an RF field 302 generally oriented along bidirectional identifying communication link 301.

Insinuating wireless device 100 continually transmits a connection request through RF field 302 oriented along bidirectional identifying communication link 301. Potential terminating wireless server device 501 receives the connection request by means of omnidirectional antenna 503 with omnidirectional field 503a, and, optionally, determines whether the connection request is valid or transmitted from a valid insinuating device. Assuming the connection request is determined to be valid, terminating wireless server device 501 transmits an acceptance of the connection request. This acceptance of the connection request is received by directional antenna 101 of insinuating wireless device 100. Those having skill in the art will recognize that alternately omnidirectional antenna 102 may be used to receive the acceptance of the connection request.

After the acceptance of the connection request has been received, insinuating wireless device 100 may transmit data to terminating wireless server device 501 using any digital format. Terminating wireless server device 501 may run a speech-to-text transmission facility and a natural language analysis facility which receives and processes voice commands from insinuating wireless device 100. Such commands may be associated with: 1) Wireless voice communication and command between a smartphone or tablet computer and computer servers from a distance; 2) Faster data access and analysis through voice command from a distance; 3) Faster troubleshooting of computer servers and mainframes through voice command from a distance; and, 4) Voice command with multiple computer servers simultaneously.

After the initial communications link has been made, IP or MAC addresses are exchanged between insinuating wireless device 100 and terminating wireless server device 501 and stored.

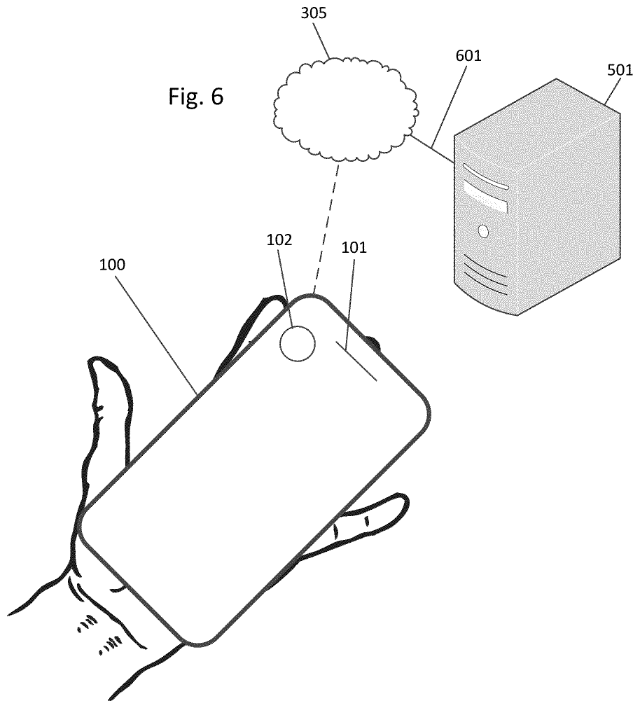

Turning now to FIG. 6, at a subsequent time, insinuating wireless device 100 and terminating wireless server device 501 may reestablish a data connection using any IP network 305. Terminating wireless server device 501 is connected to the internet by means of a wireless or a wired link 601.

While specific devices and protocols have been referenced in the specification, those having skill in the art will recognize that all obvious variants are included by reference.

What is claimed is:

1. A wireless communications service in which:
a) an insinuating wireless device transmits a connection request to a terminating wireless device using a directional antenna;
b) a terminating wireless device omnidirectionally transmits an acceptance of the connection request back to the insinuating wireless device; and
c) the insinuating wireless device changes to an omnidirectional antenna and a wireless connection is created between the insinuating wireless device and the terminating wireless device both using omnidirectional antennas.

2. A wireless communications service of claim 1 wherein mobile identification numbers (MINs) are exchanged between the insinuating wireless device and the terminating wireless device.

3. A wireless communications service of claim 2 wherein each of the mobile identification numbers (MINs) shared between the insinuating wireless device and the terminating wireless device are memorialized as contacts.

4. A wireless communications service of claim 3 wherein an MIN derived from a contact is subsequently retrieved by an insinuating wireless device and a cellular telephone call is made to a terminating wireless device.

5. A wireless communications service of claim 1 wherein the identifying IP addresses are exchanged between the insinuating wireless device and the terminating wireless device.

6. A wireless communications service of claim 5 wherein the IP addresses are shared between the insinuating wireless device and the terminating wireless device and are memorialized in a database.

7. A wireless communications service of claim 6 wherein an IP address derived from a database is subsequently retrieved by an insinuating wireless device and a data connection is made to a terminating wireless device.

8. A wireless communications service of claim 1 wherein MAC addresses are exchanged between the insinuating wireless device and the terminating wireless device.

9. A wireless communications service of claim 8 wherein the MAC addresses are shared between the insinuating wireless device and the terminating wireless device and are memorialized in a database.

10. A wireless communications service of claim 9 wherein a MAC address derived from a contact is subsequently retrieved by an insinuating wireless device and a data connection is made to a terminating wireless device.

11. A wireless communications service of claim 1 wherein the wireless internet connection is Bluetooth.

12. A wireless communications service of claim 1 wherein the wireless internet connection is LTE.

13. A wireless communications service of claim 1 wherein the wireless internet connection is WiMAX.

14. A wireless communications service of claim 1 wherein the wireless internet connection is Wi-Fi.

15. A wireless communications service of claim 1 wherein the wireless internet connection is EDGE Evolution.

16. A wireless communications service of claim 1 wherein the wireless internet connection is UMTS.

17. A wireless communications service of claim 1 wherein the wireless internet connection is EV-DO.

18. A wireless communication service of claim 1 wherein the wireless internet connection is WAP 2.0.

19. A wireless communication service of claim 1 wherein the wireless internet connection is Flash-OFDM.

20. A wireless communication service of claim 1 wherein the wireless internet connection is iBurst.

21. A wireless communications service of claim 1 wherein the wireless internet connection is used to create a VoIP connection.
